(19) United States
(12) Patent Application Publication
(10) Pub. No.: US 2006/0230032 A1
(43) Pub. Date: Oct. 12, 2006

(54) Multi-fielded Web browser-based searching of data stored in a database

(76) Inventors: Branimir I. Brankov, Lebanon, NJ (US); John Liu, Pennington, NJ (US)

Correspondence Address: LAW OFFICES OF GRADY L. WHITE, LLC, 7272 WISCONSIN AVE, SUITE 300, BETHESDA, MD, 20814, US

(21) Appl. No.: 11/396,852

(22) Filed: Apr. 3, 2006

Related U.S. Application Data
(60) Provisional application No. 60/668,598, filed on Apr. 6, 2005.

(51) Int. Cl. G06F 17/30

(52) U.S. Cl. 707/3

(57) ABSTRACT

Apparatus and method for specifying, searching and retrieving records from a remote database over an interconnected data communications network, such as the Internet, by presenting the end user with a Web-browser based user interface screen containing a results field and a plurality of user input fields configured to receive text input from the user, the text input being related to or partially identifying a person, place, institution or other entity or thing represented by a record stored in the remote database. As the user types information into the input fields on the user interface screen, the system progressively (i.e., successively) validates the information against multiple records in the remote database (preferably in real-time and on a character by character basis), and displays the results in the results field, thereby providing the end user with valuable information concerning the number and character of the hits resulting from the data entry, while the end user is still in the data entry stage.

### CROSS-REFERENCE TO RELATED APPLICATIONS

This application is related to and claims priority under 35 U.S.C. § 119 to provisional application No. 60/668,598, filed Apr. 6, 2005, which is incorporated into this application in its entirety by this reference.

### FIELD OF ART

The present invention is generally related to computerized data storage and retrieval systems and, in particular, to devices and techniques for utilizing a Web browser-based user interface to search for, select and retrieve data from remote online databases.

### RELATED ART

A variety of techniques and user interfaces have been developed to facilitate the process of searching and retrieving records from a database. Typically, these techniques and user interfaces involve displaying a single data input field on the end user's screen, permitting the end user to type one or more characters, keywords or phrases into that single data input field, searching the database and displaying to the end user (typically in list fashion) a portion of text (frequently referred to as “hits”) representing all of the records retrieved from the database that match the entered characters, keywords or phrases. Typically, the user then has to serially examine each one of the hits individually to ascertain which, if any, correspond to the record or records desired. Often, it takes a substantial and unacceptably large amount of time and effort for the end user to compose a search string that will produce a list of hits sufficiently large to incorporate the desired record, yet not so large that the process of examining the list of hits will be too burdensome.

Various techniques have been developed and adopted to speed up the data entry process and to reduce the number of “hits” returned and displayed. One such technique involves monitoring each additional character or word typed into the single input field and, to the extent possible, automatically completing the data entry for that field based on data values stored in the database, the characters, keywords or phrases entered by other end users (typically ranked according to the most popular entries), the characters, keywords or phrases entered by the current end user during previous search sessions (typically ranked by date), or some combination of some or all of these considerations.

Another technique involves providing a “drop down” list in the single input field, the drop down list containing the most recent or most popular keywords or phrases, and permitting the end user to stop typing characters at any point during data entry and use the keyboard or mouse to select one of the keywords or phrases from the drop down list. If the user makes such a selection, then the database is searched for the selected keyword or phrase.

The above-described techniques, as well as other known systems and methods for searching and retrieving records from online databases severely limit the end user's ability to selectively narrow down the search and reduce the number of hits that have to be reviewed as a result of the search. In both of the above-described techniques, for example, the user interface operates, in effect, by suggesting potential data values for the user to enter into the single input field. While these techniques will usually serve as a tip to the end user that selecting the suggested keyword or phrase will result in at least one or more hits, they do not indicate to the end user, at least not during the data entry stage, how many hits will be returned. Thus, the user typically has no true idea of the number and characteristics of the resulting hits until after a suggested keyword or phrase has already been selected, the database has already been searched, and the results have already been displayed on the screen. By this time, the user interface screen has changed, and the user is no longer able to extend or change the data entered into the input field.

Frequently, the number of hits displayed after accepting the suggested term is so large, so small, so unexpected or otherwise so unacceptable, that, in an attempt to achieve better results (i.e., a smaller, greater or more acceptable number of hits), the end user will resort to going back to the original search screen and selecting a few, or even all, of the suggested terms in the drop down list, one after another, and reviewing the results until the desired record or records are found.

Another problem associated with the above-described and other known techniques is that the data entry phase of the searching process typically focuses entirely on a single input field. As a consequence of permitting the end user to enter data in only a single field, the search performed on the database is necessarily limited to only that single record field for each record, despite the fact that many hits might be eliminated if the user were able to enter data that might be found in other record fields of the records in the database. Suppose, for example, that the end user wishes to find the database record corresponding to “John Smith” of Nome, Ak., but the user interface screen, as is typical in the prior art, permits the end user to enter and search on only the name record field. Then the user will typically have to examine a very large number of hits before finding the desired record, regardless of the fact that Mr. Smith resides in a very unusual place. If the user were able to enter Mr. Smith's city instead of his name, his search session might be expedited.

Even in cases where the user interface screen provides multiple input fields, none of the known techniques for searching remote databases have solved the problem of not providing the end user with much-needed feedback (i.e., results) during the data entry stage, when the end user still has an opportunity to effect the search by adding characters to or deleting characters from the multiple input fields.

Accordingly, there is a significant need for systems and methods for searching online databases, which provide information to the end user about the number and character of the resulting hits, during the data entry stage of the search. There is a further need in the art for such systems and methods to provide the user with a plurality of data input fields, which the user can populate in such a way as to significantly reduce the number of records that must be searched, as well as the number of hits that must be retrieved, displayed and reviewed.

### SUMMARY OF THE INVENTION

Embodiments of the invention addresse these needs, and overcome the limitations associated with the prior art by providing systems and methods for searching and retrieving data from remote databases, wherein the search is performed in response to multi-fielded data entry via a Web browser-based user interface screen and the results are dynamically displayed to the end user while the end user is still capable of entering new data for the search. In general, the invention provides an apparatus for searching a database in an interconnected data communications network comprising a client computer coupled to server computer via an interconnected data communications network, wherein the client computer includes a Web browser application configured to present to an end user a user interface screen comprising a results field and a plurality of data input fields, each one corresponding to one of a plurality of record fields in each record of the database. For instance, if each record in the database contains values for a person's family name, given name, city and specialty, then the user interface screen might contain input data fields labeled as “family name,” “given name,” “city” and “specialty,” so that there exists a correspondence between the plurality of input fields and a respective plurality of record fields in each record of the database. Notably, it is not necessary, for purposes of the present invention, for the user interface screen to include an input field corresponding to every record field in the database. The user interface screen may be implemented, for example, by utilizing a hypertext markup language (“html”) form or a macromedia flash interactive input form, both of which may be programmed to display on the end user's monitor according to methods and techniques well-known in the computer arts.

The client computer also includes a client application logic processor, which executes within the Web browser application, and which is configured to capture data entered into each one of the plurality of input fields by the end user. Based on the captured data, the client application logic processor generates a request to retrieve a set of records from the database, which records have record field values that match the data captured from the plurality of input fields. The client computer further includes a client communications interface configured to transmit the request to the server computer via the interconnected data communications network.

As will be described in more detail below, the server computer receives the request from the client computer via the interconnected data communications network, produces a set of results based on the request, and sends the set of results back to the client computer. When the set of results is received by the client computer, the client application logic processor displays the set of results in the results field on the user interface screen, thereby providing the end user with valuable information about the number and character of the hits resulting from the data entry, while the end user is still in the data entry stage.

Preferably, but not necessarily, the Web browser application is further configured to display on the user interface screen a “selected results field” (in addition to the results field and the multiple input fields), so that if the end user uses a selection device, such as a mouse, stylus, keyboard or touch screen, to select or “pick” one of the results displayed in the results field, then the client application logic processor is configured to display the selected result in the selected results field (and, optionally, delete the selected result from the set of results displayed in the results field). In some embodiments, the client application logic processor is further configured to format the set of results or the selected results prior to displaying them in the appropriate field on the user interface screen.

The client application logic processor may generate a new request every time the end user types a new character into one of the plurality of input fields. Alternatively, the client application logic processor may be configured to generate a new request every time the end user types a new word into one of the plurality of input fields. In still other embodiments, the client application logic processor may be configured to generate a new request upon expiration of a specified time limit.

Based on data stored in the database, data captured from a particular input field, and possibly the data captured from one or more other input fields on the user interface screen, the system may be able to determine in advance which character (or, in some cases, which group of characters) the end user is likely to enter next. Preferably, under these circumstances, the client application logic processor is also configured to automatically populate that particular input field with those next likely characters, thereby providing an extremely useful suggestion (or “hint”) to the end user and expediting the data entry phase of the search.

In another aspect of the present invention, there is provided a method for searching a database in an interconnected data communications network, the method comprising the steps of: (1) using a Web browser application to present to an end user a user interface screen comprising a results field and a plurality of input fields, each one of the plurality of input fields corresponding to one of a plurality of record fields in each record of the database; (2) capturing data entered into each one of the plurality of input fields by the end user; (3) generating a request to retrieve a set of records from the database, the set of records having record field values that match the data captured from said each one of the plurality of input fields, (4) transmitting the request to the server computer via the interconnected data communications network; (5) retrieving the set of records from the database; (6) producing a set of results based on the set of records retrieved from the database; (7) transmitting the set of results to the client computer; and (8) displaying the set of results in the results field on the user interface screen presented by the Web browser application.

Yet another aspect of the present invention provides a computer system for searching a remote database, comprising a Web browser application, a client logic application logic processor and a client communications interface. The Web browser application presents to the end user a user interface screen having at least one results field and a plurality of input fields, each corresponding to one of a plurality of record fields in each record of the remote database to be searched. The client application logic processor, executing within the Web browser application, captures data entered into each one of the plurality of input fields by the end user, and generates a request to retrieve a set of records from the remote database. The set of records retrieved have record field values that match the data captured from each one of the plurality of input fields. The client communications interface transmits the request to a remote server computer, via an interconnected data communications network, and receives from the remote server a set of results responsive to the generated request. Notably, the set of results received from the remote server may or may not have been produced, processed or formatted according to any particular set of rules or formatting criteria as with the alternative aspects of the invention described above.

In still another aspect of the invention, there is provided a method for searching a remote database, comprising the steps of: (1) presenting to an end user, via a Web browser application, a user interface screen comprising a results field and a plurality of input fields, each one of the plurality of input fields corresponding to one of a plurality of record fields in each record of the remote database; (2) capturing data entered into each one of the plurality of input fields by the end user; (3) generating a request to retrieve a set of records from the remote database, the set of records having record field values that match the data captured from said each one of the plurality of input fields; (4) transmitting the request to a remote server computer via an interconnected data communications network; (5) receiving from the remote server a set of results responsive to the request; and (6) displaying the set of results in the results field on the user interface screen presented by the Web browser application.

A variety of different types of Web-based database searching applications may benefit by application of the present invention, including without limitation, online searching of customer information databases, retail or wholesale product databases, genome databases, support knowledge databases, and the like.

Embodiments of the present invention permit the user to enter search terms into a plurality of data input fields simultaneously. A set of results is then displayed to the end user in an area of the screen separate from the plurality of input fields while the end user still has an opportunity to enter additional data into the input fields. Notably, the set of results being shown to the end user is based on the multiple fields, not just one input field. Embodiments of the invention also automatically populate the plurality of input fields in circumstances where the system determines what the next character or group of characters are likely to be.

Embodiments of the invention significantly reduce the number of keystrokes, commands or other actions required to enter and run a query against a remote database, thereby reducing the number of errors resulting from such keystrokes and commands. Moreover, the number of records that must be searched and the number of hits that must be displayed and reviewed are also significantly reduced.

A more complete understanding of the invention will be made apparent from the following detailed description of various embodiments of the invention in connection with the accompanying drawings and appended claims.

### BRIEF DESCRIPTION OF THE DRAWINGS

The accompanying drawings, which are incorporated in and constitute part of the specification, illustrate embodiments of the present invention, and, together with the description, serve to explain some its features.

FIG. 1 depicts a block diagram illustrating one embodiment of an apparatus for carrying out the invention.

FIG. 2 depicts a flow diagram illustrating the steps that may be performed in a client computer configured to operate according to an embodiment of the present invention.

FIG. 3 depicts a flow diagram illustrating the steps that may be performed in a server computer configured to operate according to an embodiment of the present invention.

FIGS. 4A-4E depict exemplary user interface screens suitable for use with one embodiment of the present invention, the embodiment comprising a physician survey.

FIG. 5 depicts another exemplary user interface screen suitable for use with one embodiment of the present invention.

FIG. 6 depicts a block diagram of a computer system configured to operate according to another embodiment of the present invention.

### DETAILED DESCRIPTION OF ILLUSTRATIVE EMBODIMENTS

Reference will now be made in detail to embodiments of the invention, examples of which are illustrated in the accompanying drawings. Notably, the present invention may be implemented using software, hardware or any combination thereof, as would be apparent to those of skill in the art, and the figures and examples below are meant clarify without limiting the scope of the present invention or its embodiments or equivalents.

### Overview

Embodiments of the invention may be utilized for specifying, searching and retrieving records from a remote database over an interconnected data communications network, such as the Internet. These embodiments present a user with a Web-browser based user interface screen (such as an HTML form) containing a results field and a plurality of input fields configured to receive text input from the user, the text input being related to or partially identifying a person, place, institution or other entity or thing represented by a record stored in the remote database. As the user types data into the user interface screen, the system progressively (i.e., successively) validates the data against multiple records in the remote database (preferably in real-time and on a character by character basis), and displays results in the results field, thereby indicating to the end user the number and character of results while the user still has an opportunity to enter more data into the plurality of input fields. The system validates the data by looking for matching records stored in the remote database, and, if matching records are found, showing those matching records (or some representation of those matching records) to the end user through the user interface screen. Thus, the display of matching records serves to confirm for the end user that the data entered so far is valid. Progressive validation means carrying out this validation process again and again as the end user types each new character, word or phrase into the input fields.

A first embodiment of the invention is an apparatus for searching a database in an interconnected data communications network, comprising: a client computer and a server computer coupled to the client computer via the interconnected data communications network. The client computer comprises a Web browser application configured to present to an end user a user interface screen comprising a results field and a plurality of input fields, each one of the plurality of input fields corresponding to one of a plurality of record fields in each record of the database. A client application logic processor executing within the Web browser application captures data entered into each one of the plurality of input fields by the end user and generates a request to retrieve a set of records from the database. The set of records has record field values that match the data captured from each one of the plurality of input fields. A client communications interface is configured to transmit the request to the server computer via the interconnected data communications network. The server computer comprises a results processor, which receives the request, produces a set of results based on the request, and transmits the set of results to the client computer. The server computer also comprises a database communications interface, operating under the control of the results processor, which retrieves the set of records from the database. The client application logic processor is further configured to display the set of results in the results field on the user interface screen presented by the Web browser application.

A second embodiment of the invention is a method for searching a database in an interconnected data communications network comprising the database, a client computer, and a server computer coupled to the database and the client computer. The method comprises: (1) using a Web browser application to present to an end user a user interface screen comprising a results field and a plurality of input fields, each one of the plurality of input fields corresponding to one of a plurality of record fields in each record of the database; (2) capturing data entered into each one of the plurality of input fields by the end user; (3) generating a request to retrieve a set of records from the database, the set of records having record field values that match the data captured from each one of the plurality of input fields; (4) transmitting the request to the server computer via the interconnected data communications network; (5) retrieving the set of records from the database; (6) producing a set of results based on the set of records retrieved from the database; (7) transmitting the set of results to the client computer; and (8) displaying the set of results in the results field on the user interface screen presented by the Web browser application.

A third embodiment of the invention comprises a computer system for searching a remote database, the computer system comprising a Web browser application, a client application logic processor and a client communications interface. The Web browser application is configured to present to an end user a user interface screen comprising a results field and a plurality of input fields, each one of the plurality of input fields corresponding to one of a plurality of record fields in each record of the remote database. The client application logic processor, executing within the Web browser application, is configured to capture data entered into each one of the plurality of input fields by the end user, and to generate a request to retrieve a set of records from the remote database, the set of records having record field values that match the data captured from each one of the plurality of input fields. The client communications interface is configured to transmit the request to a remote server computer via an interconnected data communications network, and to receive from the remote server a set of results responsive to the request. Then the client application logic processor displays the set of results in the results field on the user interface screen presented by the Web browser application.

A fourth embodiment of the invention comprises a method for searching a remote database. The method comprises the steps of: (1) using a Web browser application to present to an end user a user interface screen comprising a results field and a plurality of input fields, each one of the plurality of input fields corresponding to one of a plurality of record fields in each record of the remote database; (2) capturing data entered into each one of the plurality of input fields by the end user; (3) generating a request to retrieve a set of records from the remote database, the set of records having record field values that match the data captured from each one of the plurality of input fields; (4) transmitting the request to a remote server computer via an interconnected data communications network; (5) receiving from the remote server computer a set of results responsive to the request; and (6) displaying the set of results in the results field on the user interface screen presented by the Web browser application.

In some embodiments, the progressive validation is carried out every time the user types a character by selecting, retrieving and displaying in the results field any records from the database that match the information the user has typed so far. In other embodiments, the progressive validation may be carried out, for example, every time the user types a complete word, a complete sentence or hits the “enter” key to signal that the input is complete. In still other embodiments, the progressive validation may be carried out according to criteria unrelated to the user's keystrokes, such as upon expiration of a specified time period.

In addition to progressively validating the user's input against the records stored in the remote database, the system also simultaneously displays to the user (preferably in list form) the names and/or addresses of persons, places, institutions or other entities represented by records in the database that match the user's input so far, thereby providing progressive “hints” to the user so that the user may see and select the desired record without having to enter a complete set of identifying information for that record. Preferably, the system is also configured to display additional instructional text (e.g., “Were you looking for one of the records in this list?”) in order to prompt the user to review and select the desired record from the results field. By providing these progressive hints while the end user is still in the data entry stage of the search, and permitting the user to select the desired record from a list of records matching input that may be partial or incomplete, the system significantly diminishes the number of spelling, typographical and identification errors that might otherwise occur during a user search session, and, consequently, the time, effort and resources required to detect and resolve such errors.

The system can simultaneously receive and process (i.e., search for, validate and provide the appropriate hints) data corresponding to multiple fields in each record of the database. Thus, for example, if the user interface screen presented to the end user, as well as the records stored in the database, contain three fields (e.g., family name, given name and address), and the end user types only one character in each field (e.g., “s,” “j” and “5”), then the system will, preferably in real time, search for, validate and display a set of results in the results field, the set of results representing records in the database having values in those three fields that match the three entered characters (e.g., the records representing “Jane Smith of 5211 μm Street,” “Joseph Simpson of 509 Oak Street,” and “Jonathan Sanford of 58 La Cienaga Blvd.”). Moreover, the focus of the search, and therefore the number of entries in the results field, will be refined and/or narrowed each time the user types in an additional character. In this example, for instance, typing in the letter “m” after the letter “s” in the family name field will eliminate from the results field the entries for Joseph Simpson and Jonathan Sanford.

Although the preference is to display the set of results in real time, the system may also be configured to wait until a critical mass of characters or words have been entered and captured before searching the database for values matching the data captured from the plurality of input fields.

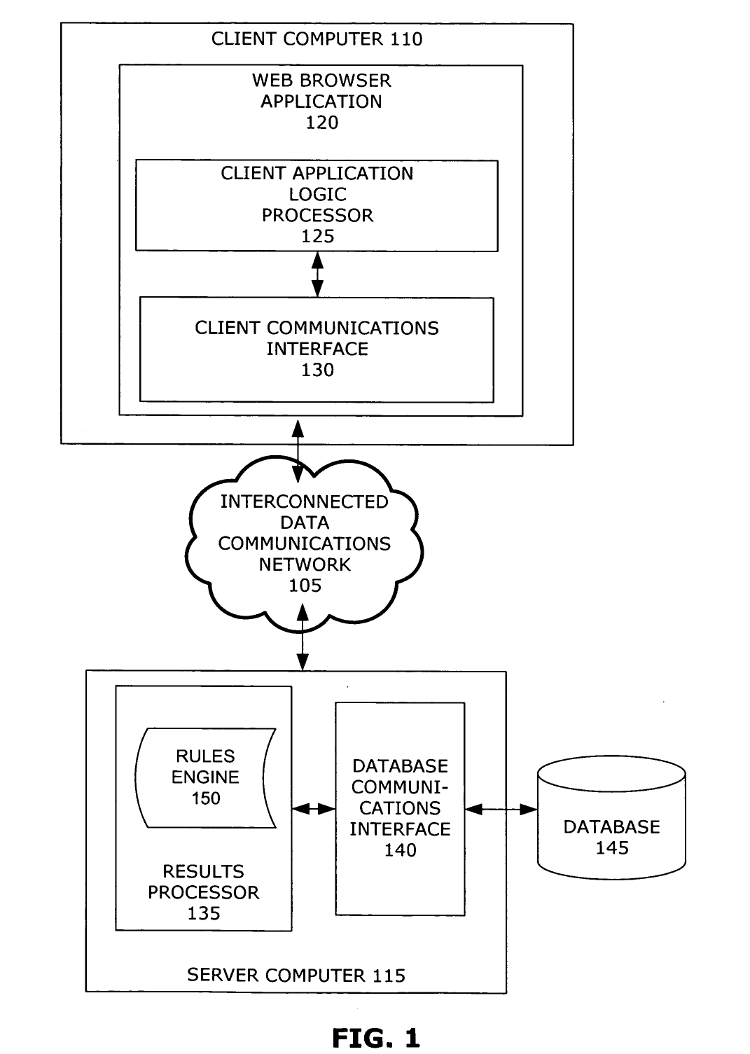

Turning to the drawings, FIG. 1 is a block diagram of an exemplary hardware and software environment consistent with an embodiment of the invention. As shown in FIG. 1, client computer 110 is coupled to interconnected data communications network 105, which is in turn coupled to server computer 115. Server computer 115 is also coupled to database 145, which typically stores a multiplicity of related data records. Interconnected data communications network 105 may comprise, for example, a local area network, a wide area network, a corporate intranet or the Internet.

Client computer 110 usually comprises one of a variety of different types of Web-enabled and networked computers, computing systems or workstations, including, for example, desktop or laptop computers, mini-computers, mainframes, handheld computers, personal digital assistants and mobile cell phones having interactive display screens. Client computer 110 is linked to interconnected data communications network 105 via one or more categories of conventional wired or wireless network communications equipment, such as analog, digital subscriber lines (DSL) or cable broadband modems, Ethernet cards and cables, 802.11 wireless cards and routers, and Bluetooth® wireless adaptor cards and links, and the like.

Client computer 110 includes a Web browser application 120, client application logic processor 125 and client communications interface 130. Preferably, Web browser application 120 is programmed in JavaScript and configured to execute within any standard Web browser, such as Microsoft Internet Explorer® (MSIE) or Netscape®, for example. JavaScript is an interpreted programming or script language available from Netscape, and which is used in Web site development to do such things as creating a drop down list on a Web page, automatically changing a formatted date on a Web page, causing a linked-to page to appear in a popup window and causing text or graphic images to change during a mouse rollover operation. JavaScript code can be imbedded in hyper text markup language (HTML) pages and interpreted by the Web browser (or client). Other interpreted programming or script languages, such as Microsoft's Visual Basic, Sun's Tcl, the UNIX-derived Perl, and IBM's Rexx, may also be used to implement Web browser application 125, as they are all somewhat similar in function and capacity to JavaScript. In general, script languages are easier and faster to code in than the more structured and compiled languages such as C and C++, or Java, the compiled object-oriented programming language derived from C++. Script languages generally take longer to process than compiled languages, but are very useful for shorter programs.

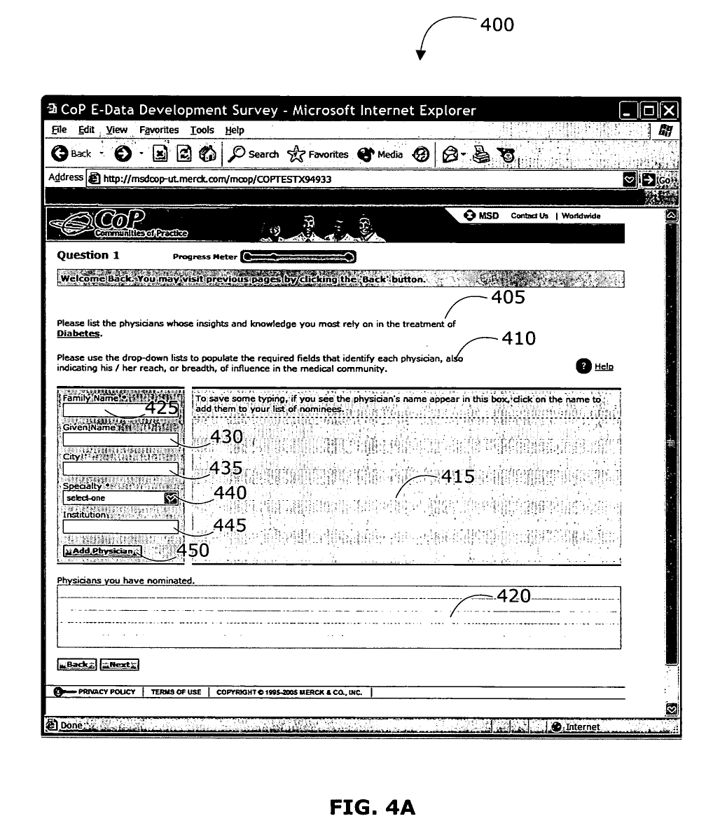

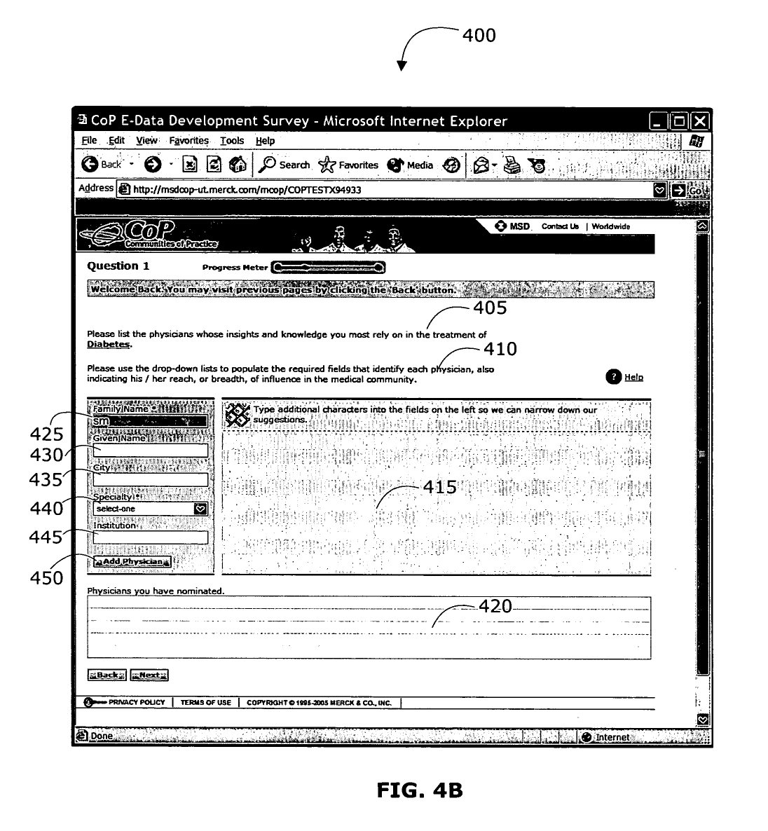

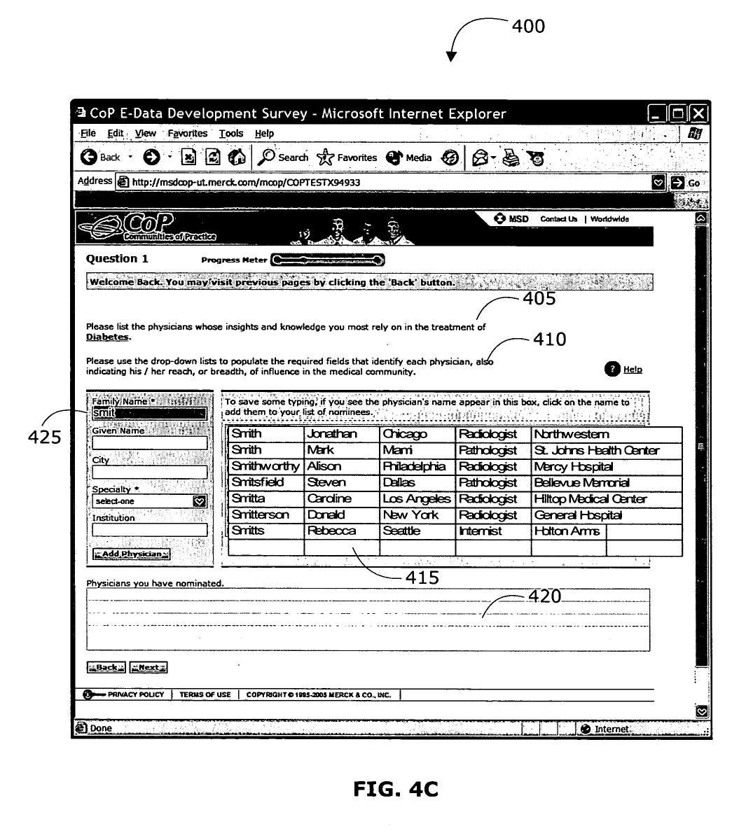

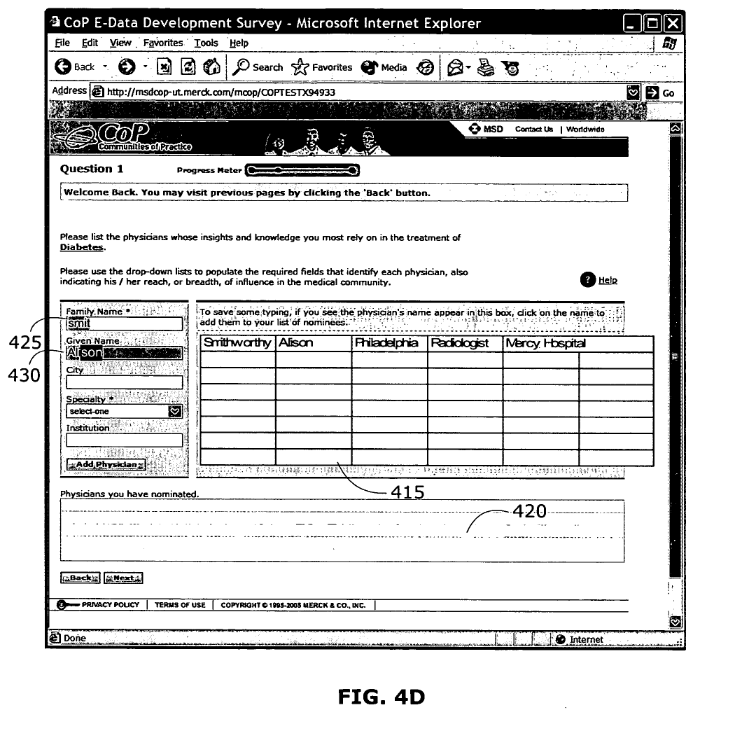

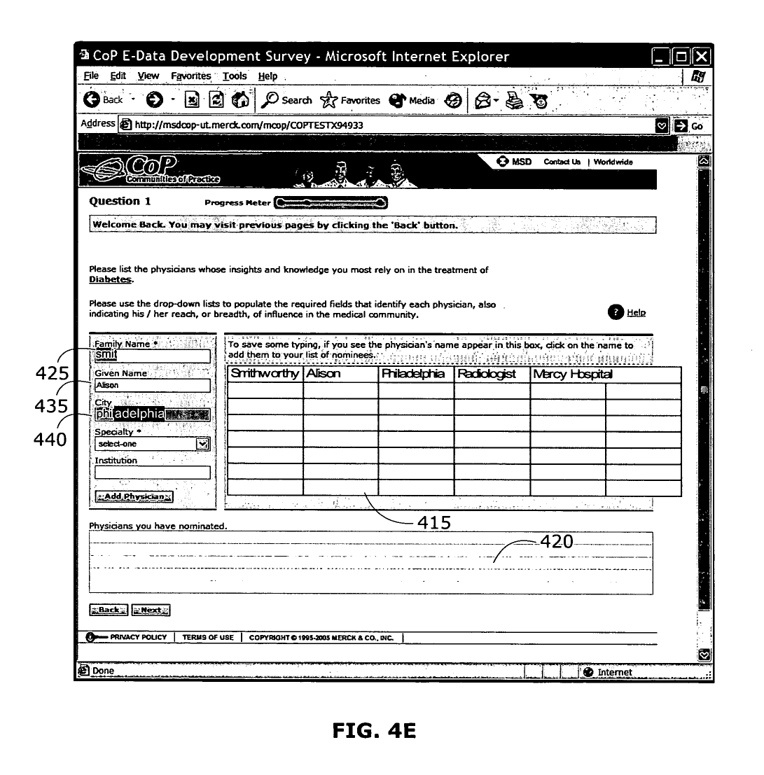

In this case, Web browser application 120 is programmed to display a user interface screen containing a plurality of input fields and a results field on a display screen or monitor (not shown in FIG. 1) connected to client computer 110. Each one of the input fields corresponds to a record field existing in each record of the database to be searched. Web browser application 120 also displays on the user interface screen a selected results field. One example of a suitable user interface screen, containing the plurality of input fields, the results field and the selected results field, is discussed below with reference to FIG. 4A.

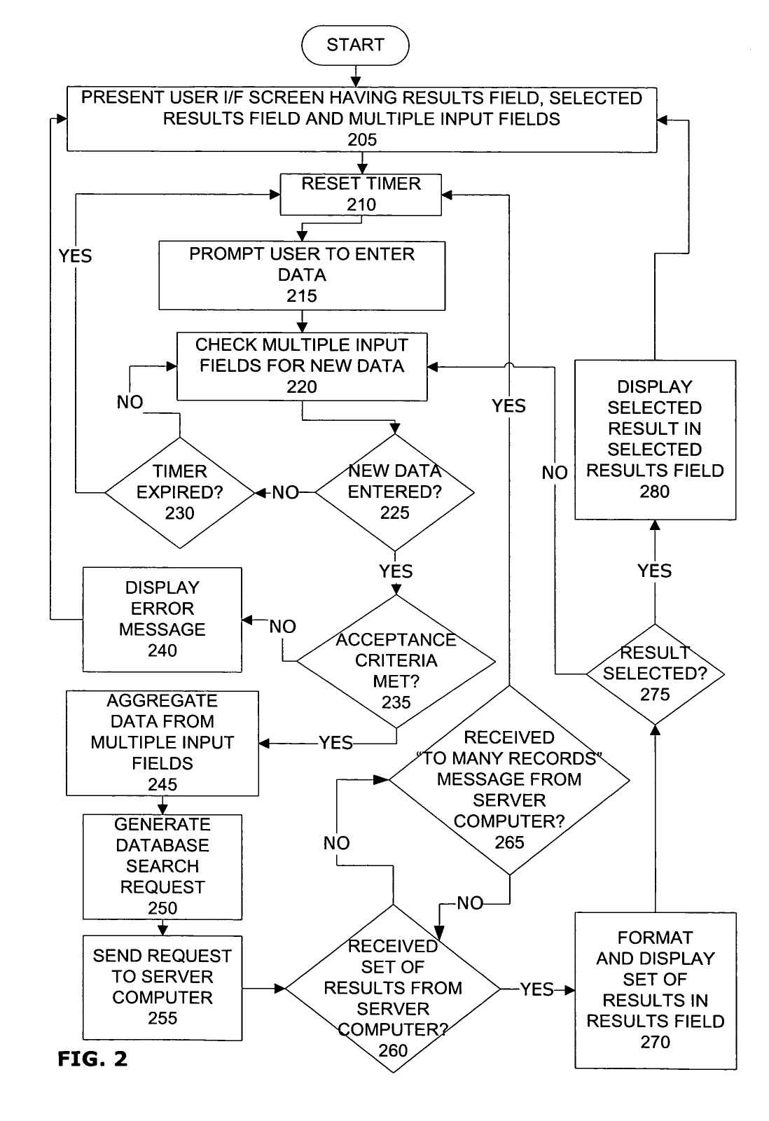

Client application logic processor 125 is a program, application module or applet, which executes within Web browser application 120, and which makes it possible for the end user to interact with the user interface screen presented by Web browser application 120. Client application logic processor 125 monitors the user interface screen and captures data entered into the plurality of input fields by the end user. Based on the captured data, client application logic processor 120 generates a request to retrieve from the database records that have record fields that match the values entered into the plurality of input fields by the end user. As will be discussed below with reference to FIG. 2, for performance and efficiency considerations, it may be necessary or desirable to configure client application logic processor 125 to generate the request only after the entered and captured data meets certain specified acceptance criteria. Client communications interface 130 (preferably another JavaScript program) sends the request to server computer 115 via interconnected data communications network 105.

Server computer 115 comprises a results processor 135, an optional rules engine 150 and database communications interface 140. Results processor 135, which may be programmed using any suitable programming language (although JAVA may be preferred), receives the request transmitted from client computer 110 and produces the set of results eventually displayed by client application logic processor 125 on the user interface screen presented by Web browser application 120. Typically, this will be accomplished by performing multiple queries against database 145 (i.e., one query for each of the multiple input fields) and forming a set of results from the set of records that match all such multiple queries. For example, results processor 135 will retrieve a first group of records which all have a record field value that matches the first input field (e.g., family name), a second group of records which all have a record field value that matches the second input field (e.g., given name), a third group of records which all have a record field value that matches the third input field (e.g., specialty), and then form the set of results from the intersection of the first, second and third groups of records.

Database communications interface 140, operating under control of results processor 135, typically performs the task of actually accessing (i.e., performing the multiple queries against) database 145 to retrieve each group of records responsive to the data captured from each one of the input fields so that the results processor can use these groups of records to produce the set of results. After producing the set of results, the results processor 135 transmits the set of results back to client computer 110 via interconnected data communications network 105.

In some embodiments, the set of results may comprise one or more record field values stored in the set of records retrieved from database 145 in response to the request. In alternative embodiments, each result in the set of results may simply comprise a string of text that uniquely identifies the appropriate record in the database, instead of actual record field values from records stored in the database. For example, although the data in the record fields of a particular record in the database may constitute several different types of data (e.g., date, string or numeric), the result created by results processor 135 to represent this record to the end user on the user interface screen may be a pure text string formed by combining and/or transforming the values stored in the record fields. So, for example, if the request causes request processor 135 to retrieve a record from database 145 having three different data types (e.g., NAME=“John Smith,” AGE=“42” and BIRTHDATE=“Nov. 20, 1963”), results processor 135 may represent this record in the set of results with a single string of text (e.g., “John Smith, 42, b. Nov. 20, 1963”). Results processor 135 is configured to produce results having a variety of different data types, including, but not limited to, strings, numbers, images, graphics, sound and animation.

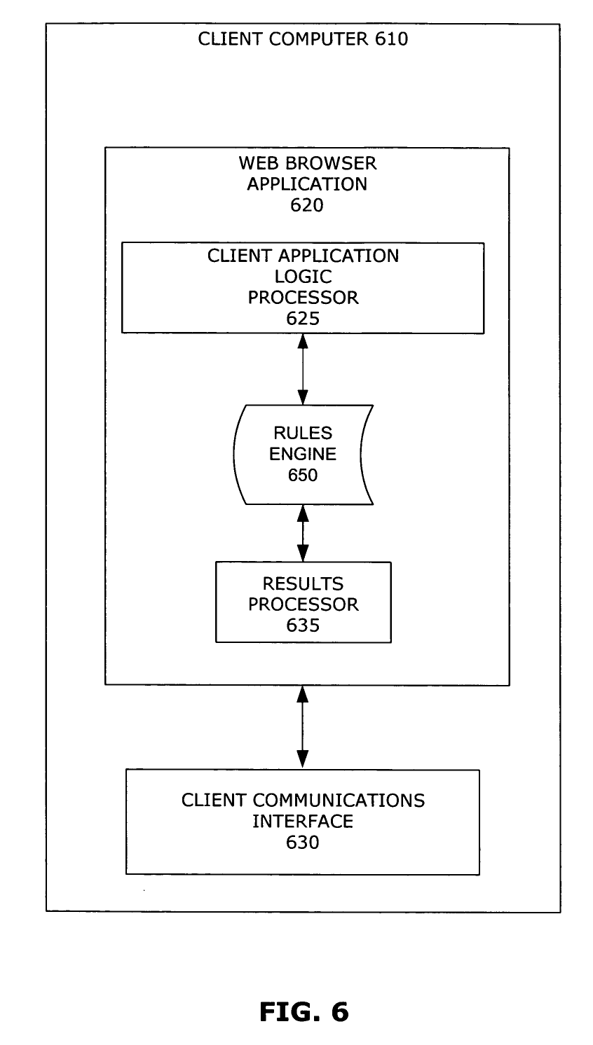

The set of results is preferably produced according to one or more rules defined by optional rules engine 150. Rules engine 150 may reside within server computer 115 (as shown in FIG. 1), on client computer 110 (as shown in FIG. 6 and discussed below), or elsewhere in the network, depending on the requirements of the particular computing environment. Rules engine 150 may comprise a multiplicity of different processing rules that will be applied by rules processor 135 to the set of records retrieved from database 145 by database communications interface 140. For example, rules engine 150 may include a rule specifying a maximum number, a minimum number, or both a maximum and minimum number of records to include in the set of results that will be sent back to client computer 110. If the request received from client computer 110 would result in the retrieval of too many or too few records, thereby causing a violation of this rule, then results processor 150 may be configured to send a message to client computer 110 indicating this fact, instead of sending a set of results. If client computer 110 receives such a message, then client application logic processor 125 executing on client computer 110 may be configured to prompt the end user to enter additional characters, and to capture and transfer these additional characters to server computer 115. Hopefully, the new request (and new data) will lead results processor 150 to retrieve a set of records that does not violate any of the rules contained in rules engine 150.

Rules engine 150 may also include one or more rules to support “fuzzy logic” functionality, which allows the system to select and retrieve records from database 145 that may not precisely match the data entered by the end user, but which nevertheless may be what the end user intended. Under fuzzy logic principles, for example, the system can be configured to retrieve and return records having a given name record field value of “Steve,” Stephen” or “Stephanie,” even though the data captured from the given name input field by client application logic processor 125 is “Steven.” To implement this logic, one or more rules in rules engine 150 may cause results processor 135 to include in the set of results records retrieved from database 145 having record field values that are spelled in a manner similar to the spelling of the data captured from the plurality of input fields. Similarly, the system may be configured to select and return records that are phonetically equivalent to the data captured from the plurality of input fields (i.e., records having record field values that are pronounced in a manner similar to the pronunciation of the data captured from the plurality of input fields).

When certain values are captured from certain input fields on the user interface screen, it may be necessary or desirable, for performance optimization reasons, to perform a “pre-search” of database 145 using data captured from less than all of the input fields, to assign greater or lesser weight to certain input field values, or even to disregard certain input field values, prior to performing the main search. One can assume, for example, that in a very large database containing the family names of people who live in the United States, a search operation that puts too much focus on a captured family name input field value that happens to be “Smith” or “Jones,” is likely to produce too many results to be particularly useful. Under these circumstances, substantial performance improvements may be achieved, for example, by configuring the system to delay, defer or even refrain from searching on certain input field values (e.g., when the field FAMILY_NAME=“Smith”) until after performing searches on some or all of the other input fields. Using such a rule as an operation parameter, the system can substantially narrow down the number of records that may have to be selected, retrieved, processed, sorted, formatted and/or displayed at any one time, thereby increasing the overall speed and efficiency of the system. Accordingly, embodiments of rules engine 150 may include one or more rules that cause results processor 135 to refrain from searching the database based on certain input field data values until data is captured from one of the other input fields, to disregard certain data values during the search of the database, or to temporarily delay searching the database when certain input fields have specified data values.

Although FIG. 1 illustrates an embodiment of the invention wherein server computer 115 is directly connected to database 145, and database 145 resides outside of server computer 115, it will be appreciated by those skilled in the art that embodiments of the invention may be implemented using alternative network configurations, including configurations wherein database 145 is a component of server computer 115, configurations wherein database 145 is directly connected to and accessed through interconnected data communications network 110, and configurations wherein database 145 is connected to some other computer system or network (not shown in FIG. 1), which is linked to or accessed via interconnected data communications network 105.

FIG. 2 depicts a flow diagram illustrating the steps that may be performed in a client computer system, such as client computer 110 depicted in FIG. 1, configured to operate according to embodiments of the present invention. First, at step 205, the system presents a user interface screen having a results field, a selected results field and multiple input fields. Then the system resets a timer (step 210) and prompts the user to enter data (step 215). Next, the system checks the multiple input fields for new data (steps 220 and 225). If no new data has been entered, the system checks whether the timer has expired (step 230). If the timer has expired, processing returns to step 210, where the timer is reset again, and the system prompts the user again to enter new data (step 215). If, however, the timer has not expired, the system continues to execute the loop formed by steps 220, 225 and 230, thereby continuously checking for new data and timer expiration.

If the system determines at step 225 that the user has entered new data, then the next step (step 235) determines whether certain acceptance criteria has been met. The system may be configured, for example, to confirm that the end user has not entered the wrong type of data into any of the input fields (e.g., entering a number like “1234,” into the GIVEN NAME input field, or entering a text string like “David” into an OCCUPATION input field configured to accept only one of a limited number of specialties, like “Radiologist”). If the acceptance criteria has not been met, an error message is displayed on the user interface screen (step 240), and processing returns to the first step (step 205), where the user interface screen is presented to the user again. On the other hand, if the system determines at step 235 that the acceptance criteria has been met, then all of the captured data is aggregated (step 245), to generate a database search request (step 250), which is then sent to the server computer (step 255).

At this point, the system enters a loop which determines whether and what kind of response was received from the server computer, as illustrated in steps 260 and 265 of FIG. 2. At 260, the system determines whether a set of results has been received. If not, the system next determines whether the server has instead returned a “too many records” message (step 265). If such a message has been received, then processing returns again to steps 210 and 215, where the timer is reset and the user is prompted again to enter data. Hopefully, this will cause the end user to enter additional data, which will be sufficient to permit the server computer to retrieve matching records from the database without exceeding any record retrieval limits (such as may be defined by a rules engine residing on the server). However, if the system determines at step 265 that the “too many results” message has not been received, then processing returns again to step 260, to determine whether a set of results has come in.

If a set of results is received at step 260, then, at step 270, the system formats the set of results and displays the formatted set of results in the results field on the user interface screen. The system next determines, at step 275, whether the user has selected a particular result from the results field. If not, then processing returns to step 220, where the system checks to see if new data has been entered into the input fields. But if the user has selected one of the results, then the selected result is displayed in the selected results field (step 280), and processing returns to again to the first step, step 205, where the user interface screen is presented. In some embodiments, execution of step 205 may clear the multiple input fields, the results field and the selected results field. In other embodiments, it may be necessary or desirable to retain the data displayed in these fields, so that the end user will be able to see and review previously-returned and/or previously-selected results and, if desired, continue adding characters to partially-populated input fields.

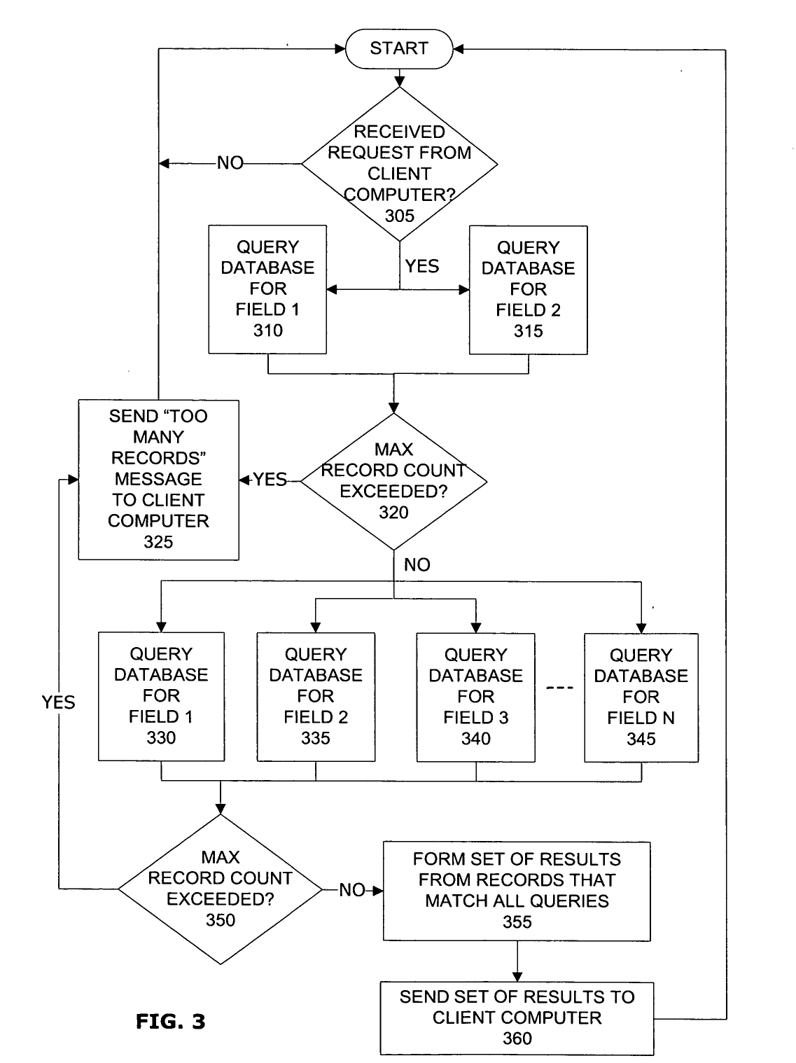

FIG. 3 depicts a flow diagram illustrating the steps that may be performed in a server computer system, such as server computer 115 depicted in FIG. 1, configured to operate according to embodiments of the present invention. First, at step 305, the system determines whether a request has been received from the client computer. If not, processing returns to “start.” If a request has been received, however, the system does a “pre-search” of the database (at steps 310 and 315) for all records having record field values matching the data captured from the first two fields (fields 1 and 2). The “pre-searching” steps are optional performance optimization steps, which are executed in some embodiments of the invention, in order to narrow down the number of records that will have to be processed in subsequent steps.

Next, at step 320, the system determines if searching the database for records having matching record field values for fields 1 and 2 causes too many records to be retrieved from the database. If so, the system sends a “too many records” message to the client computer (step 325) and processing returns again to the starting point of the flow chart (labeled “start” in FIG. 3). If the “too many records” message was not received, then the system next performs queries of the database using all of the input fields (steps 330, 335, 340 and 345), including fields 1 and 2. The queries are configured to retrieve all of the records in the database that match the values entered into all of the multiple input fields. When these records are retrieved, the system determines again, at step 350, whether the maximum record count has been exceeded. Notably, the maximum record count used at step 350 may be different from the maximum record count used in step 320. If the maximum record count is exceeded, then processing returns again to step 325, where a message indicating that the data entered into the search fields would cause “too many records” to be retrieved is sent to the client computer. However, if it is determined at step 350 that the maximum record count has not been exceeded, then the system (and more specifically, the results processor discussed above), forms a set of results from the matching records (step 355) and sends that set of results to the client computer (step 360). At this point, processing returns, once again, to “start.”

FIGS. 4A-4E depict exemplary user interface screens suitable for use with an embodiment of the present invention configured to implement an online survey. In this case, the survey participants are asked to provide answers to questions related to their reliance on certain physicians for the treatment of certain conditions, such as diabetes. The survey application is coupled to a remote database containing detailed information (i.e., names, addresses, specialties, etc.) for the physicians. As shown in FIG. 4A, the system uses a Web browser application to display user interface screen 400 on the end users computer system. User interface screen 400 has multiple input fields 425, 430, 435, 440 and 445, a results field 415 and a selected results field 420. In some embodiments, user interface screen 400 also includes an appropriate set of instructions, prompts and buttons (405, 410 and 450, respectively) explaining to the end user how to begin conducting the search.

In FIG. 4B, the end user begins typing a family name into input field 425. In this case, the user has typed in the first two characters “s” and “m” of the family name. However, since the input supplied so far would cause too many records to be displayed, no results are displayed in results field 415.

FIG. 4C depicts the user interface screen 400 after the user has typed the first four characters of the family name (“smit”) into input field 425. Since the end user has now typed enough characters into the input field to narrow down the number of records retrieved from the database, the system displays a set of results in the results field 415. All the results displayed in results field 415 match the data entered into input field 425 so far.

As illustrated by FIG. 4D, the end user has stopped entering data into the family name field 425 and has instead entered three characters of the given name (“ali”) into the given name field 430. Now, the end user has typed enough characters into the family and given name fields (415 and 430) to refine the set of results down to one physician (“Alison Smithworthy”). Accordingly, the system retrieves data from the “Alison Smithworthy” record in the database and displays that information in results field 415. Since only one record matches the data entered into the input fields, the system is also configured to automatically complete the data entry of the given name field 430 (in this case, supplying the letters “son”). In FIG. 4E, the end user begins typing the name of a city into the city field 440, although no further refinement is necessary or possible because only one record matches the data previously-entered. Again, the system automatically supplies characters to complete the population of the city field (in this case supplying the characters “adelphia”). The end use can continue typing data into these input fields or simply hit enter to select the characters supplied by the system. The automatic completion of input field data in this fashion typically saves the end user a significant amount of time in the data entry phase and also reduces the number of errors caused by mistyping input data.

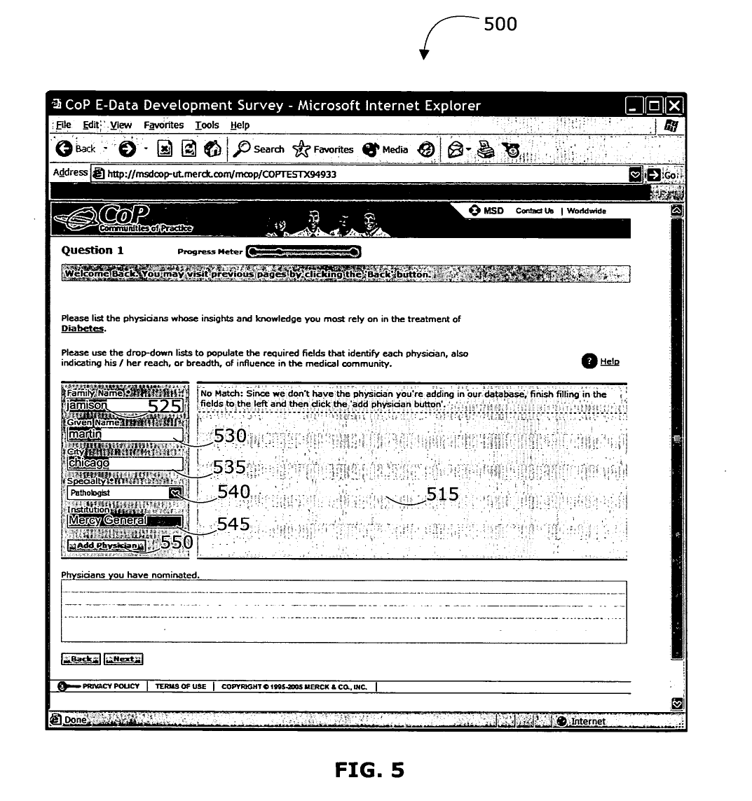

FIG. 5 depicts another exemplary user interface screen suitable for use with one embodiment of the present invention. In this scenario, the end user has entered information concerning a person not already entered into the database. Since there are no records in the database that match the data entered by the end user into input fields 525, 530, 535, 540 and 545, no results are displayed in the results field 515. The end user can add this person to the database by selecting the “ADD PHYSICIAN” button 550.

It should be apparent to those skilled in the art, upon reading this disclosure, that some of the functions described above with reference to server computer 115, such as function of processing the set of records according to a set of rules to produce a set of results suitable for display to and selection by the end user, may not be necessary, depending, for example, on the kind of database being searched and the type of record field values contained in the database. It might be sufficient, necessary or desirable, for example, to simply display to the end user all of the records found in the database that match the captured data without performing any kind of hinting, validation, error-checking performed by result processor 135 on the these records.

It may also be necessary or desirable, depending on the particular database application, the computing environment, and the extent of the available resources at the remote server level, to carry out some of the error-checking and result processing functions on the end user's local computer system (i.e., the client computer), rather than on the server computer. In some embodiments, some or even all of the error-checking, performance optimization and result processing functions may be shared (or intentionally duplicated) between various components of both the client computer and the server computer. Embodiments of the present invention may be usefully applied in all of these situations.

Consistent with these possibilities, FIG. 6 depicts a block diagram of a computer system configured to operate according to another embodiment of the present invention. As shown in FIG. 6, client computer 610 comprises Web browser application 620, client application logic processor 625 and client communications interface 630, which are configured to operate in substantially the same manner as Web browser application 120, client application logic processor 125 and client communications interface 130, respectively, discussed above with reference to FIG. 1. Unlike the embodiment shown in FIG. 1, however, client computer 610 also includes results processor 635 and rules engine 650, which perform substantially the same functions as results processor 135 and rules engine 150, respectively, also discussed above with reference to FIG. 1.

When the set of results is received from the remote server, client application logic processor 625 displays the set of results in the results field on the user interface screen presented by Web browser application 620. Results processor 635 processes the set of results according to a set of rules defined by optional rules engine 650. Thus, results processor 635 may be configured, for example, to monitor or check the set of results returned from the remote server to ensure that a specified maximum number of results has not been exceeded. In appropriate cases, results processor 635 is configured to send client application logic processor 625 a message indicating that the server has returned too many results, which preferably causes client application logic processor 625 to prompt the end user to enter more characters into one or more input fields.

Rules engine 650 (or, in some cases, a separate such optional rules engine) residing on the end user's local computer system may define the criteria used by client application logic processor 625 to generate the request for matching records. Thus, client application logic processor 625, operating according to the set of rules in rules engine 650, may be configured to assign certain weights to certain input field values, to delay generating or sending a request until a certain number of characters have been captured, and/or to modify the order of database search requests depending on the captured data.

Rules engine 650 also may comprise a set of rules (a set of rules can also be a single rule) to support the fuzzy logic functionality, as described above. Based on these fuzzy logic rules, client application logic processor 635 may be configured to generate a request that will retrieve records from the database that do not have record field values exactly matching the data captured from the input fields, but which may have been what the end user intended.

As with the other aspects of the invention, client computer 610 also includes a selection device (not shown in FIG. 6), such as a mouse, and, when the end user uses the selection device to select a particular result from the set of results displayed in the results field, client application logic processor 625 displays that particular result in the selected results field on the user interface screen.

The above-described embodiments are intended to illustrate the principles of the invention, but not to limit its scope. Various other embodiments, modifications and equivalents to these embodiments may occur to those skilled in the art upon reading the present disclosure or practicing the claimed invention. Such variations, modifications and equivalents are intended to come within the scope of the invention and the appended claims.

What is claimed is:

1. An apparatus for searching a database in an interconnected data communications network, comprising:
a client computer; and
a server computer coupled to the client computer via the interconnected data communications network;
the client computer comprising
a Web browser application configured to present to an end user a user interface screen comprising a results field and a plurality of input fields, each one of the plurality of input fields corresponding to one of a plurality of record fields in each record of the database;
a client application logic processor executing within the Web browser application, configured to capture data entered into said each one of the plurality of input fields by the end user, and to generate a request to retrieve a set of records from the database, the set of records having record field values that match the data captured from said each one of the plurality of input fields, and
a client communications interface configured to transmit the request to the server computer via the interconnected data communications network;
the server computer comprising
a results processor, which receives the request, produces a set of results based on the request, and transmits the set of results to the client computer, and
a database communications interface, operating under control of the results processor, which retrieves the set of records from the database;
wherein the client application logic processor is further configured to display the set of results in the results field on the user interface screen presented by the Web browser application.

2. The apparatus of claim 1, wherein each result in the set of results comprises a string of text uniquely identifying a record in the database.

3. The apparatus of claim 1, wherein each result in the set of results comprises a record field value from a record in the database.

4. The apparatus of claim 1, wherein
the user interface screen further comprises a selected results field;
the client computer further comprises a selection device; and
responsive to manipulation of the selection device by the end user to select a particular result from the results field, the client application logic processor is further configured to display the particular result in the selected results field.

5. The apparatus of claim 1, wherein the client application logic processor is further configured to format the set of results for display in the results field on the user interface screen.

6. The apparatus of claim 1, wherein the results processor produces the set of results according to a set of rules defined by a rules engine.

7. The apparatus of claim 6, wherein the set of rules comprises a rule specifying a limit on the number of records the results processor will include in the set of results.

8. The apparatus of claim 7, wherein the results processor is further configured to send the client computer a message indicating that the set of results exceeds the limit.

9. The apparatus of claim 8, wherein, responsive to receiving the message, the client application logic processor is further configured to prompt the end user to enter additional characters.

10. The apparatus of claim 6, wherein the set of rules comprises a rule causing the results processor to include in the set of results records from the database having record field values that are spelled in a manner similar to the spelling of the data captured from the plurality of input fields.

11. The apparatus of claim 6, wherein the set of rules comprises a rule causing the results processor to include in the set of results records from the database having record field values that are pronounced in a manner similar to the pronunciation of the data captured from the plurality of input fields.

12. The apparatus of claim 6, wherein the set of rules comprises a rule causing the results processor to disregard data captured from at least one of the plurality of input fields.

13. The apparatus of claim 6, wherein the set of rules comprises a rule causing the results processor to delay producing the set of results until additional data is captured from the plurality of input fields.

14. The apparatus of claim 1, wherein the client application logic processor is further configured to generate a new request upon entry of a new character into one of the plurality of input fields.

15. The apparatus of claim 1, wherein the client application logic processor is further configured to generate a new request upon entry of a new word into one of the plurality of input fields.

16. The apparatus of claim 1, wherein the client application logic processor is further configured to generate a new request upon expiration of a specified time limit.

17. The apparatus of claim 1, wherein the client application logic processor is further configured to automatically populate an input field.

18. In an interconnected data communications network comprising a database, a client computer, and a server computer coupled to the database and the client computer, a method for searching the database, comprising:
presenting to an end user, via a Web browser application, a user interface screen comprising a results field and a plurality of input fields, each one of the plurality of input fields corresponding to one of a plurality of record fields in each record of the database;
capturing data entered into said each one of the plurality of input fields by the end user;
generating a request to retrieve a set of records from the database, the set of records having record field values that match the data captured from said each one of the plurality of input fields, and
transmitting the request to the server computer via the interconnected data communications network;
retrieving the set of records from the database;
producing a set of results based on the set of records retrieved from the database;
transmitting the set of results to the client computer; and
displaying the set of results in the results field on the user interface screen presented by the Web browser application.

19. The method of claim 18, wherein each result in the set of results comprises a string of text uniquely identifying a record in the database.

20. The method of claim 18, wherein each result in the set of results comprises a record field value from a record in the database.

21. The method of claim 18, further comprising
displaying a selected results field on the user interface screen;
receiving from the end user data representing a selection of a particular result from the results field; and
responsive to the selection, displaying said particular result in the selected results field.

22. The method of claim 18, further comprising formatting the set of results for display in the results field on the user interface screen.

23. The method of claim 18, further comprising:
providing a rules engine; and
producing the set of results according to a set of rules defined by the rules engine.

24. The method of claim 23, wherein the set of rules comprises a rule specifying a limit on the number of records included in the set of results.

25. The method of claim 24, further comprising sending the client computer a message indicating that the set of results exceeds the limit.

26. The method of claim 25, further comprising prompting the end user to enter additional characters.

27. The method of claim 18, further comprising including in the set of results records from the database having record field values that are spelled in a manner similar to the spelling of the data captured from the plurality of input fields.

28. The method of claim 18, further comprising including in the set of results records from the database having record field values that are pronounced in a manner similar to the pronunciation of the data captured from the plurality of input fields.

29. The method of claim 18, further comprising disregarding data captured from at least one of the plurality of input fields.

30. The method of claim 18, further comprising the step of delaying production of the set of results until additional data is captured from the plurality of input fields.

31. The method of claim 18, further comprising generating a new request upon entry of a new character into one of the plurality of input fields.

32. The method of claim 18, further comprising generating a new request upon entry of a new word into one of the plurality of input fields.

33. The method of claim 18, further comprising generating a new request upon expiration of a specified time limit.

34. The method of claim 18, further comprising the step of automatically populating an input field.

35. A computer system for searching a remote database, comprising:
a Web browser application configured to present to an end user a user interface screen comprising a results field and a plurality of input fields, each one of the plurality of input fields corresponding to one of a plurality of record fields in each record of the remote database;
a client application logic processor executing within the Web browser application, configured to capture data entered into said each one of the plurality of input fields by the end user, and to generate a request to retrieve a set of records from the remote database, the set of records having record field values that match the data captured from said each one of the plurality of input fields; and
a client communications interface configured to transmit the request to a remote server computer via an interconnected data communications network, and to receive from the remote server a set of results responsive to the request;
wherein the client application logic processor is further configured to display the set of results in the results field on the user interface screen presented by the Web browser application.

36. The computer system of claim 35, wherein each result in the set of results comprises a string of text uniquely identifying a record in the remote database.

37. The computer system of claim 35, wherein each result in the set of results comprises a record field value from a record in the remote database.

38. The computer system of claim 35, further comprising:
a selection device; and
a selected results field displayed on the user interface screen;
wherein, responsive to manipulation of the selection device by the end user to select a particular result from the results field, the client application logic processor is further configured to display the particular result in the selected results field.

39. The computer system of claim 35, wherein the client application logic processor is further configured to format the set of results for display in the results field on the user interface screen.

40. The computer system of claim 35, further comprising:
a rules engine; and
a results processor configured to process the set of results according to a set of rules defined by the rules engine.

41. The computer system of claim 40, wherein the set of rules comprises a rule specifying a limit on the number of records the results processor will include in the set of results.

42. The computer system of claim 41, wherein the results processor is further configured to send the client application logic processor a message indicating that the set of results exceeds the limit.

43. The computer system of claim 42, wherein, responsive to receiving the message, the client application logic processor is further configured to prompt the end user to enter additional characters.

44. The computer system of claim 40, wherein the set of rules comprises a rule causing the results processor to include in the set of results records from the remote database having record field values that are spelled in a manner similar to the spelling of the data captured from the plurality of input fields.

45. The computer system of claim 40, wherein the set of rules comprises a rule causing the results processor to include in the set of results records from the remote database having record field values that are pronounced in a manner similar to the pronunciation of the data captured from the plurality of input fields.

46. The computer system of claim 35, further comprising:
a rules engine; and
wherein the client application logic processor is further configured to generate the request according to a set of rules defined by the rules engine.

47. The computer system of claim 46, wherein the set of rules comprises a rule causing the client application logic processor to disregard data captured from at least one of the plurality of input fields.

48. The computer system of claim 46, wherein the set of rules comprises a rule causing the client application logic processor to delay generating the request until additional data is captured from the plurality of input fields.

49. The computer system of claim 35, wherein the client application logic processor is further configured to generate a new request upon entry of a new character into one of the plurality of input fields.

50. The computer system of claim 35, wherein the client application logic processor is further configured to generate a new request upon entry of a new word into one of the plurality of input fields.

51. The computer system of claim 35, wherein the client application logic processor is further configured to generate a new request upon expiration of a specified time limit.

52. The computer system of claim 35, wherein the client application logic processor is further configured to automatically populate an input field.

53. A method for searching a remote database, comprising:
presenting to an end user, via a Web browser application, a user interface screen comprising a results field and a plurality of input fields, each one of the plurality of input fields corresponding to one of a plurality of record fields in each record of the remote database;
capturing data entered into said each one of the plurality of input fields by the end user;
generating a request to retrieve a set of records from the remote database, the set of records having record field values that match the data captured from said each one of the plurality of input fields;
transmitting the request to a remote server computer via an interconnected data communications network;
receiving from the remote server computer a set of results responsive to the request; and
displaying the set of results in the results field on the user interface screen presented by the Web browser application.

54. The method of claim 53, wherein each result in the set of results comprises a string of text uniquely identifying a record in the remote database.

55. The method of claim 53, wherein each result in the set of results comprises a record field value from a record in the remote database.

56. The method of claim 53, further comprising:
providing a selection device;
displaying a selected results field displayed on the user interface screen; and
responsive to manipulation of the selection device by the end user to select a particular result from the results field, displaying the particular result in the selected results field.

57. The method of claim 53, further comprising the step of formatting the set of results for display in the results field on the user interface screen.

58. The method of claim 53, further comprising:
providing a rules engine; and
processing the set of results according to a set of rules defined by the rules engine.

59. The method of claim 58, wherein the set of rules comprises a rule specifying a limit on the number of records the results processor will include in the set of results.

60. The method of claim 58, further comprising the step of determining that the set of results exceeds the limit.

61. The method of claim 60, further comprising the step of prompting the end user to enter additional characters.

62. The method of claim 58, further comprising the step of including in the set of results records from the remote database having record field values that are spelled in a manner similar to the spelling of the data captured from the plurality of input fields.

63. The method of claim 58, further comprising the step of including in the set of results records from the remote database having record field values that are pronounced in a manner similar to the pronunciation of the data captured from the plurality of input fields.

64. The method of claim 53, further comprising the steps of:
providing a rules engine; and
generating the request according to a set of rules defined by the rules engine.

65. The method of claim 64, further comprising the step of disregarding data captured from at least one of the plurality of input fields.

66. The method of claim 64, further comprising the step of delaying generation of the request until additional data is captured from the plurality of input fields.

67. The method of claim 53, further comprising the step of generating a new request upon entry of a new character into one of the plurality of input fields.

68. The method of claim 53, further comprising the step of generating a new request upon entry of a new word into one of the plurality of input fields.

69. The method of claim 53, further comprising the step of generating a new request upon expiration of a specified time limit.

70. The method of claim 53, further comprising the step of automatically populating an input field.
